(19) United States
(12) Patent Application Publication
(10) Pub. No.: US 2012/0055718 A1
(43) Pub. Date: Mar. 8, 2012

(54) ELECTRONIC SCALE FOR RECORDING HEALTH ADMINISTRATION DATA

(76) Inventor: Jiunn-Rong CHEN, Taichung City (TW)

(21) Appl. No.: 13/226,278

(22) Filed: Sep. 6, 2011

(30) Foreign Application Priority Data
Sep. 7, 2010 (CN) 201010273978.7

(51) Int. Cl. G01G 23/38

(52) U.S. Cl. 177/3

(57) ABSTRACT

An electronic scale for recording health administration data comprises: a micro controller, a food database module, a weight sensing device, an identification module, the food database module, and the user database module. The micro controller has at least an embedded application for processing data input, output, analysis, and calculation. The food database module is provided for storing detailed food data item. The weight sensing device comprises a weight platform for receiving the food for weight measuring and sensing the food weight. The identification module is provided for identifying the data in an identification tag of the food for weight measuring. The data identified by the identification module is used to map to the corresponding food and the associated data in the food database module for performing analysis and calculation in the micro controller. The nutrition information such as nutrition components, calories of the food for measuring is displayed on a screen so as to provide recommendation intake quantity and warnings to user, and stores the recorded data of user diet in a user database module.

### BACKGROUND OF THE INVENTION

1. Field of the Invention

The present invention relates to an electronic scale device. In particular, it relates to an electronic scale device for identifying the food items via the identification module, or inputting the food items directly or searching the food items by food categories to map to the corresponding food and the associated data in the food database module for performing analysis and calculation. The nutrition information such as nutrition components, calories of the food for measuring is displayed on a screen so as to provide recommendation intake quantity and warnings to user, and stores the recorded data of user diet in a user database module.

2. Description of Prior Art

With the rapid changes occurred to daily environment along with the economic growth and wealthy life style, the general diet has improved greatly compared to the past. There are many people suffer from diseases, in particular hyperglycemia or obesity, which are related to inappropriate diet as a result of having big meals frequently on business occasions. Over nutrition become a major factor resulting in the arteriosclerosis and cardiovascular diseases. Accordingly, diet control is a good method for prevention and managing of the diseases.

The prior art methods for calculating diet calories and nutrition intake use a food database and an input device built-in in an electronic scale. The food database is provided for storing data such as categories, names, calories, nutrition, and nutritional content of general food items. An electronic scale is used for measuring the food weight, and the input device is used for inputting the food items. The corresponding food items and the associated data are provided in the food database for performing computation. Further, the information such as weights, calories, nutrition and nutritional contents of the food items are displayed on the screen of the electronic scale as the references to users for determining if the diet is balanced.

However, the prior art food database in an electronic scale contains large quantities of data which comprise names, contents, brands, manufacturers and flavors and each search inquiry of a food item demands large amount of resources. A complete food database covers numerous data entries of similar food items made by various flavors, brands, and manufacturers. Accordingly, it is inconvenient and resource consuming when performing search by entries of corresponding food items in a database having numerous entries. Though it is efficient and time saving to directly input a food item or brand when performing a search inquiry, alternative names of one food item such as yam/potato or prune/jujube may be a trouble to users. Frequently, directly inputting the food items when perform a search inquiry of the corresponding food item may fail in finding an identical item. In another search method, food items are code-allocated and a search inquiry is done by inputting a food code. Yet, it becomes inconvenient to memorize or searching for the correct food code before the search inquiry especially when there are many food codes.

In another aspect, a prior art electronic scale displays information such as calories, nutritional contents after computation on a screen and the information cannot be stored. In addition, the electronic scale does not provide warning functions such as excessive intake or insufficient intake when a user's diet is unbalanced based on the daily, weekly or long-term data analysis. Accordingly, users are not informed of detailed diet status which can be useful in correcting inappropriate diet habits instantly.

### SUMMARY OF THE INVENTION

In summary, the data searching with an electronic scale based on the prior art technologies is time consuming and inconvenient, the food information such as calories and nutritional contents resulted from calculation is displayed but not stored, and excessive intake warnings are not provided. Users and health administrators are not fully informed of the diet status and the benefits are limited as a result. In order to resolve the above disadvantages, an electronic scale for recording health administration data is provided based on years of research and development experiences.

The present invention provides an electronic scale for recording health administration data, comprises: a micro controller, a food database module, a weight sensing device, an identification module, and a screen. The micro controller installed in the electronic scale has at least an embedded application for processing data input, output, analysis, and calculation. The food database module installed in the electronic scale is connected with the micro controller, and has detailed food data item therein. The weight sensing device installed in the electronic scale is connected with the micro controller, and the weight sensing device has a weight platform for receiving the food for weight measuring whereby the food weight is sensed by the weight sensing device. The identification module is connected to the micro controller for identifying the data in the identification tag of the food for weight measuring. The screen is electronically connected with the micro controller for displaying the operating interface of the embedded application. The user database module installed in the electronic scale for establishing connections to the micro controller and having at least a user data and at least a recorded data of user diet stored therein; firstly, the identification module promptly retrieves the food related detailed data in or from the identification tag. Secondly information records of calories and nutrition components in the food are calculated, displayed and stored after the weight platform measuring the food weight, Thirdly the information records are matched with the total consumed food data of the user for providing an intake excessive warning or an intake insufficient warning for the user if indicated.

The object of the present invention is to provide an electronic scale whereby the identification module promptly retrieves the food related detailed data in or from the identification tag. The inconvenience of manual search is avoided. The weight platform measures the food weight, and calculates food information such as calories and nutrition components to display on the screen.

The second object of the present invention is to provide an electronic scale with a food database module having a general food database and a daily food database. The data in the general food database comprises detailed data of food available in the market. The data of daily food database comprises detailed data of food frequently consumed by the user. The data in the food database module can be updated at user's disposal so as to assure that the data stored therein is complete and precise. When performing manual search inquiries, the daily food database provides a shortcut for effectively reducing the searching time.

The third object of the present invention is to provide an electronic scale with a user database module having a diet recorded database and a diet recommendation database. The diet recorded database is provided for storing user diet data for recording user diet profiles. The diet recommendation database is provided for recording default standard values of personal diet, which is used as the basis in the comparison with the total consumed food data of the user. The comparison provides diet excessive intake warnings or diet insufficient warnings to users, which is the reference to adjust one's diet.

The fourth object of the present invention is to provide an electronic scale installed with a connection device for establishing connections with an external system. The external system comprises a medical service platform, where the diet data in the diet recorded database is uploaded to the medical service platform via the connection established, so that doctors, dieticians and case managers are fully informed of user's diet status. Consequently, intake quantity and updated diet recommendations based on individual user status and conditions are sent to the diet recommendation database.

The fifth object of the present invention is to provide an electronic scale with an input device installed. When the food does not have the identification tag, users can input the food items or perform search inquiry by food categories so as to match the corresponding food and the associated data in the food database module. The food information resulted from weight measuring and calculation is used for references to users on nutrition intake status.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic diagram of major constitutional units according to the present invention;

FIG. 2 is a schematic diagram of user scenarios according to the present invention;

FIG. 3 is a schematic diagram of the constitutional units of the user database module according to the present invention;

FIG. 4 is a schematic diagram of the constitutional units of the food database module according to the present invention;

FIG. 5 is a schematic diagram of the identification module for identifying two dimensional barcode according to the present invention;

FIG. 6 is a schematic diagram of the identification module for identifying three dimensional barcode according to the present invention;

FIG. 7 is schematic diagram of the constitutional units of another embodiment according to the present invention;

FIG. 8 is schematic diagram of the constitutional units of an external system according to the present invention; and

FIG. 9 is schematic diagram of the constitutional units of the other two embodiments according to the present invention.

### DETAILED DESCRIPTION OF THE INVENTION

Embodiments are provided in the followings in order to further detail the implementation of the present invention in the summary. It should be noted that objects used in the diagrams of the embodiments are provided with proportions, dimensions, deformations, displacements and details are examples and the present invention is not limited thereto and identical components in the embodiments are the given same component numbers.

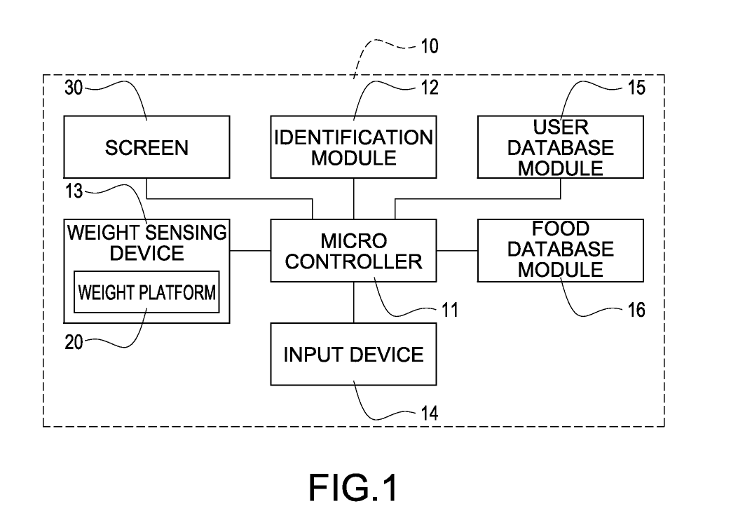

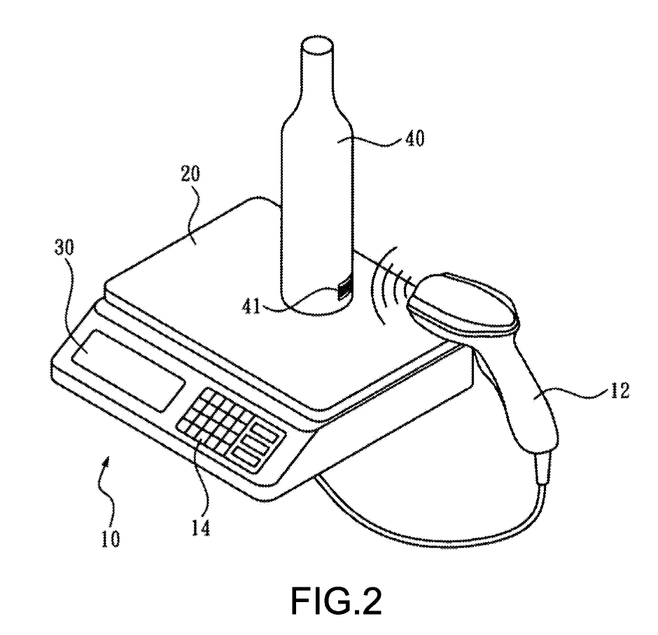

As shown in FIG. 1 and FIG. 2, an electronic scale for recording health administration data 10 comprises a micro controller 11, an identification module 12, a weight sensing device 13, an input device 14, a user database module 15, a food database module 16, and a screen 30.

The micro controller 11, the weight sensing device 13, the user database module 15, the food database module 16 are installed in the electronic scale 10. The identification module 12, the weight sensing device 13, the input device 14, the user database module 15, the food database module 16 are connected with the micro controller 11. The weight sensing device 13 comprises a weight platform 20 installed on the electronic scale 10 for receiving a food 40 to measure. The weight sensing device 13 is used for weight measuring by sensing the weight of the food 40.

The micro controller 11 has at least an embedded application for processing data for processing data input, output, analysis, and calculation. The screen 30 is installed externally on the electronic scale 10 and electrically connected with the micro controller 11. The screen 30 is used as the operation interface of the embedded application. Users operate on the embedded application via the input device 14 in order to process the consumed food data. The input device 14 is installed with an ON/OFF button and a return to zero button. The ON/OFF button is provided for switching the power of the weight platform 20 and the return to zero button is provided for performing the return to zero function of the weight platform 20 of the electronic scale 10.

The food for weight measuring 40 is installed with an identification tag 41. The identification tag 41 has the data of the corresponding food 40. The identification module 12 is provided for identifying the data in the identification tag 41. The identification tag 41 can be printed on the packages of the food 40, on a product hang tag or other means combining with the food 40.

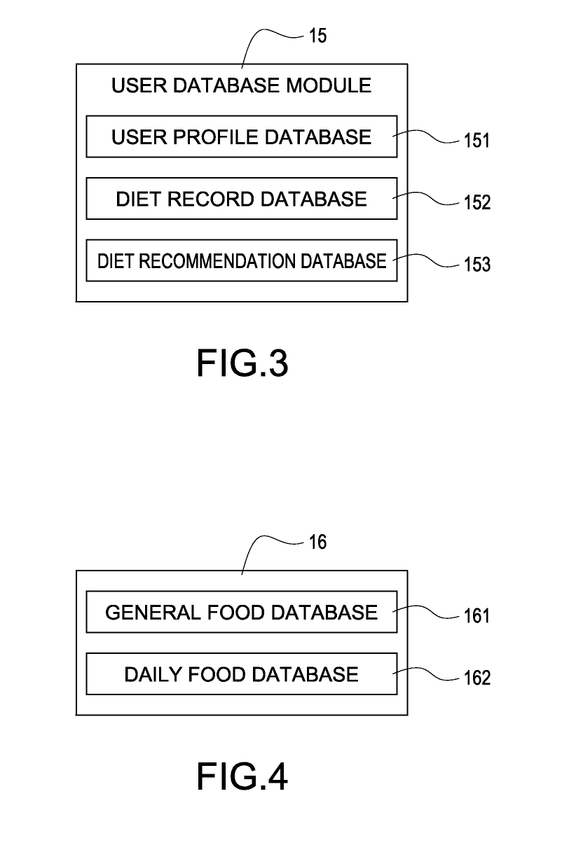

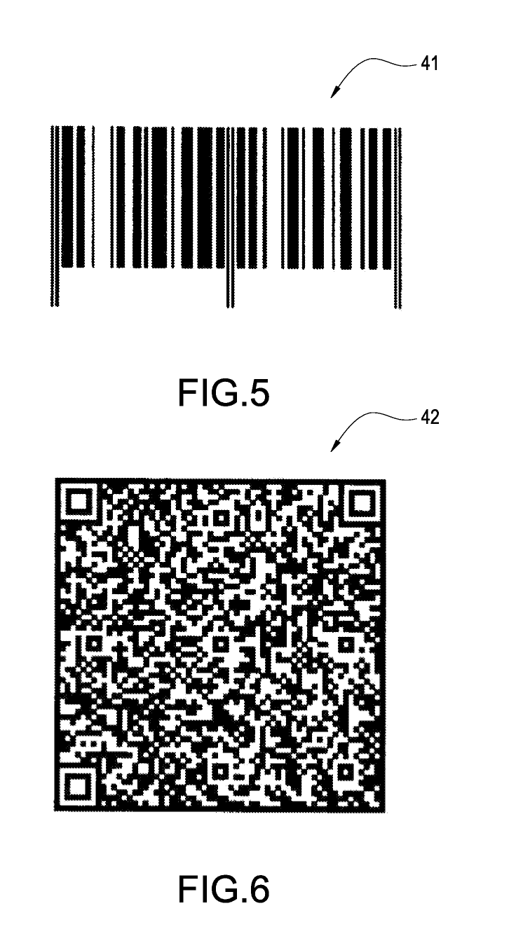

As shown in FIG. 3, the user database module 15 comprises a user profile database 151 and a diet recorded database 152 and a diet recommendation database 153. The data in the user profile database 151 at least comprises user information such as name, age, height, weight, diseases, special conditions (pregnancy) etc, and the diet recorded database 152 is used for storing diet data of a period such that users can access afterwards. The diet recommendation database 153 has related data such as personal default standard values of total daily intake calories, particular nutrition recommendation or intake quantity limits data generated according to the user information such as name, age, height, weight, diseases, and special conditions. The user data in the user database module 15 can be added, edited, deleted, inquired and printed.

As shown in FIG. 4, the food database module 16 comprises a general food database 161 and a daily food database 162. The data of the general food database 161 comprises detailed data of food items available in the market, which include as food names, calories, nutrition, nutritional quantity, edible effects. The food can be uncooked food items such as raw pork, beef, fish, vegetables, rice, flours etc. and the food can also be cooked compound food items such as beef noodles, dumplings, fried vegetables, deep fried chips, pizzas etc. The data of the daily food database 162, having the data of the food items which users consumes frequently, is used to provide ways of quick and convenient search for those food items users consumes frequently. The data of the food database module 16 can be displayed on the screen 30. Users read and select on the data displayed on the screen via input device 14. The food data of the food database module 16 can be added, edited, deleted, inquired and printed.

Followed by the introduction on the general structure, the following provide details of embodiments according to the present invention. The user data can be inputted in advance via the input device 14 and stored in the user database module 15. The user data can be data for one user and the user database module 15 provides auto logon and display user data. The user data can be data for a plurality of users. Each user is required to input correct user ID to log on to the user database module 15.

The identification tag 41 can be a barcode. The barcode can be a two dimensional barcode or a three dimensional barcode as shown in the FIG. 6. Currently, the food available in the market is packaged with the proprietary barcode and serial numbers. The identification tag 41 can includes data such as the manufacturer and food items of the food 40. The identification module 12 is a barcode identifier for identifying the barcode tag. The data such as the manufacturer and food items of the food 40 is promptly identified by the identification module 12 via identifying the identification tag 41. The data is used for matching with the data of the corresponding food 40 in the food database module 16. The identification tag 41 can be a chip tag or an electronic tag, for example, wireless radio frequency identification tag (RFID tag). The identification tag 41 can further include data such food contents, calories, and nutrition component in addition to the manufacturer and food items of the food 40. The identification module 12 is a RFID reader for identifying the chip tag and electronic tag. Data such as the food composition, calories, and nutrition component quantity recorded in the identification tag 41 can be different by batches. In the method using a chip tag or an electronic tag, the precision is improved by updating the batch differences of the food 40 in addition to that the identification module 12 reads related data of the food 40 promptly. On the other hand, when food manufactures introduce new products or change food formula, the data can be updated real-time by identifying the data in the tag.

As shown in FIG. 2, after the user ID is authorized by the user database module 15, the food 40 for weight measuring is placed on the weight platform 20. The identification module 12 identifies the data of the identification tag 41 on the food 40, or data identification is completed before the weight measuring. When the weight sensing device 13 senses the weight of the food 40, the micro controller 11 identifies the food data via the identification module 12. The corresponding food and the associated data is matched among the food database module 16 and then nutritional information is calculated. The weight of the food 40 and the food information such as calories, nutrition components is displayed on the screen 30. The diet recorded database 152 is used for storing the diet data of the user for keeping diet history of the user.

The total consumed food data of the users are stored in the diet recorded database 152. When the consumed quantity approximates to the critical points of the default standard values, reminding messages are displayed on the screen 30 and a comparison is performed between the total consumed food data with default standard values in the diet recommendation database 153. The reminding messages are used for reminding the users to lower the intake quantity. When consumed quantity is above or below the default standard values, warning messages are provided to the users as excessive intake or insufficient intake. When the food 40 is placed on the weight platform 20, the user is informed to adjust by reducing, or increasing the intake quantity of the food 40.

By the above operations, the identification module 12 is used for promptly inputting the data of the food 40 with the identification tag 41 to make the operation more convenient to users. In terms of many food items or uncooked food materials purchased from the traditional market, there are no identification tags 41 for identification. Then, users may input directly the corresponding food item with the input device 14, or using food categories to look for corresponding food data in the food database module 16 in an inquiry.

Considering many items of food 40 may include shell or peels such as egg shells, shrimp shells and fruit peels or the items of food 40 is placed in containers. In order to generate a more precise analysis on the consumed food data, the food redundant percentage information can be added to the food database module 16 and the micro controller 11 calculates the edible amount based on the food redundant percentage information of the food 40. The micro controller 11 can further measures the weights of the food 40 before and after eating then analyzes data according to the exact consumed quantity by deducting the weight of the food container and portion not eaten.

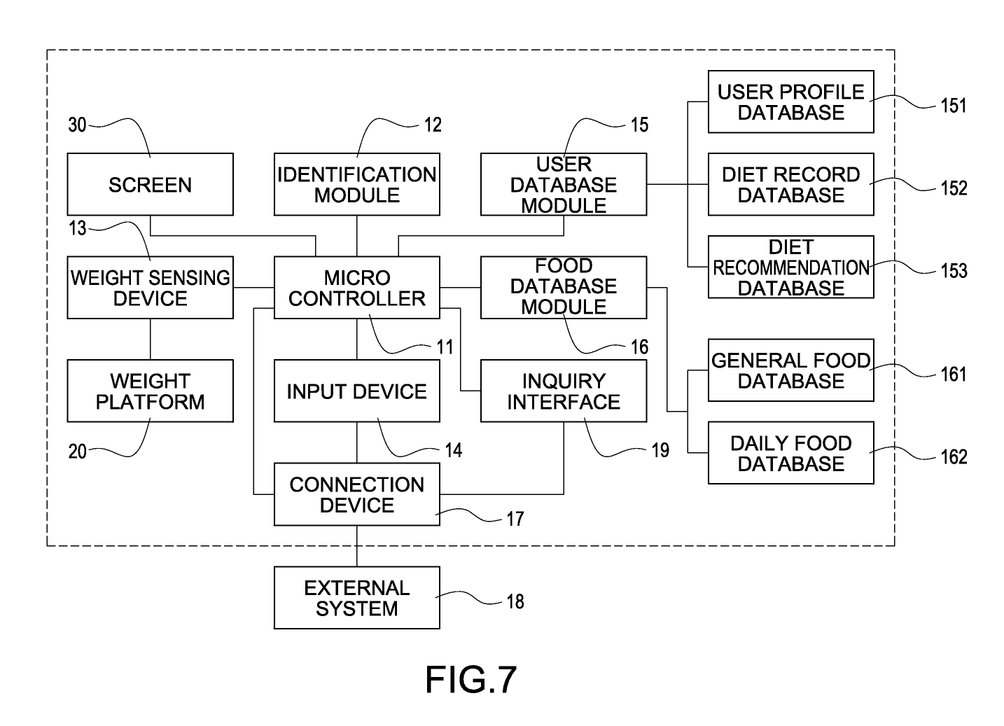

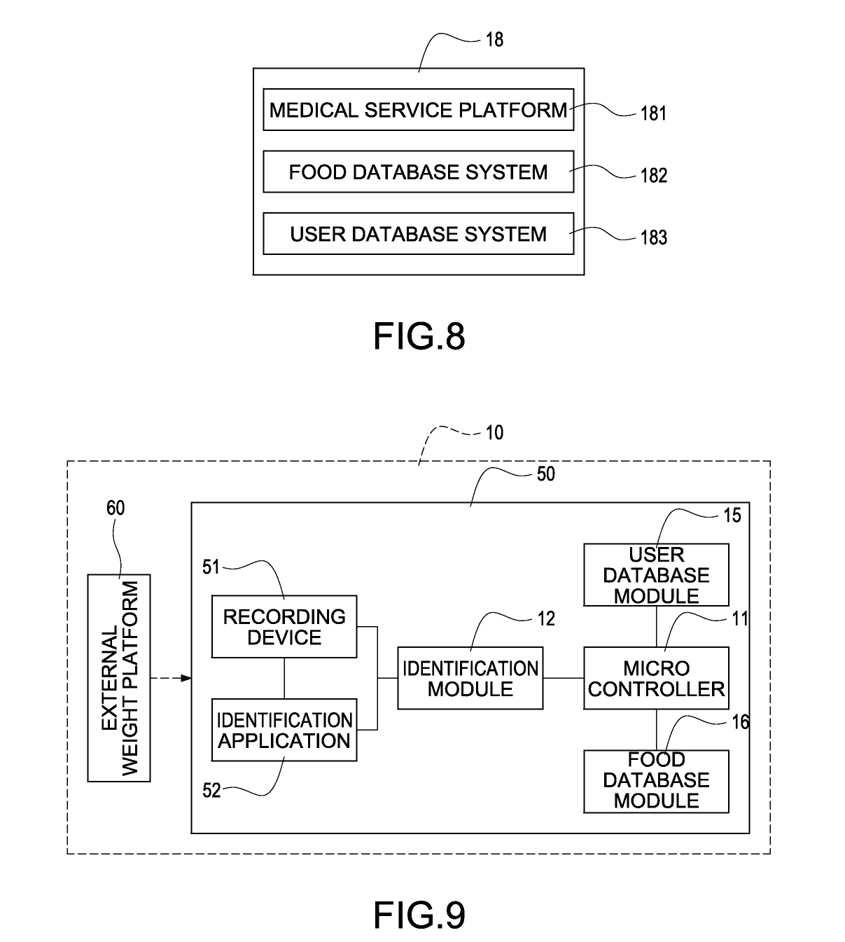

Another embodiment of the present invention is shown in the FIG. 7 and FIG. 8. The electronic scale 10 is installed with a connection device 17 for establishing connections to the micro controller 11. The embedded application of the micro controller 11 comprises an inquiry interface 19 to display on the screen 30. The connection device 17 is used for establish connections with an external system 18. The external system 18 comprises a medical service platform 181, a food database system 182, and a user database system 183. The medical service platform 181 can be a medical institute such as an independent medical institutions or a health administration center. The information data is transmitted via the connection between the connection device 17 and the medical service platform 181 and displayed on the screen 30 via the inquiry interface 19. The users can log on to the food database system 182 by inputting the user ID and the password and updates the data in the food database module 16. When a user log on to the user profile database 151, a connection is established with the external system 18 via the connection device 17. The user database system 183 verifies the user data with the data in the user profile database 151 in order to authorize user ID. The diet data in the diet recorded database 152 is uploaded to the medical service platform 181 upon the user ID is authorized so as to assure that the medical professionals in the medical units involved in the medical caring such as doctors, dieticians or health administrators are fully informed of the user diet status and provide the user recommendation intake quantity based on the user data along with the user status and conditions. Further, an warning is displayed on the inquiry interface 19 of the screen 30 when the overall status is above or below the default standard values to remind the users to reduce, stop or increase the intake quantity of the food 40 in one's diet. Diet medical recommendations provided by the medical service platform 181 is sent and stored in the diet recommendation databas 153. The users are allowed to access to the data so as to understand the diet status and observe if the diet content and the intake quantity are balanced during a particular time period and optimize the health by diet contents and intake quantity. Medical care providers such as doctors, dieticians or health administrators are allowed to update diet medical recommendation based on the real-time user conditions and assist the user to improve the health by performing diet controls. Also, the diet medical recommendations can be provided to users by emails or mobile phone messages. Users can take photos of food and upload the photos to the medical service platform 181 via computers and personal mobile devices in addition to using the inquiry interface 19 and access to the information of the food 40 such as calories and nutrition. Another embodiment of the present invention demonstrates alternative configurations of the input device 14. The input device 14 can be a plurality of buttons or an external keyboard to the electronic scale 10, or combines with the screen 30 as a touch screen (touch panel) where users operate by touching the screen. The touch screen design reduces total structural volume and is more convenient for users to operate. The input device 14 is used for inputting instructions via the operation interface of the micro controller 11. The user data and food data can be inputted directly and stored in the user database module 15, the food database module 16. Also, the input device 14 can be a voice recognition device or visual recognition device. The input process is then quick and convenient by using voice recognition for inputting the user data and the items of the food 40 via voices, and using the visual auto recognition device for inputting the user data and the items of the food 40 via recognizing images or films, such as using face recognition and finger prints recognition to identify users.

FIG. 9 is schematic diagram of the constitutional units of the other two embodiments according to the present invention. As shown in FIG. 9, the identification module 12 and the micro controller 11, and the food database module 16, the user database module 15 are installed in a portable device 50. The portable device 50 can be a mobile phone, a PDA or a notebook computer. A recording device 51 in the portable device 50 such as a mobile phone built-in camera, PDA built-in recording system, and notebook computer built-in camera is installed in an identification application 52 of the portable device 50 to form the identification module 12. This embodiment is integrated with an external weight platform 60. The external weight platform 60 connects with the portable device 50. The user measures the weight of the food 40 via the external weight platform 60, transmits the weight information to the portable device 50 via USB interfaces or other transmission means and records images of the food 40 via the recording device 51. The identification module 12 transforms the images as the information for identification. The identified data and weight information is used for the computation along with the matched corresponding food and the associated data in the food database module 16. Further, the information such the weight, calories, and nutrition components of the food 4 is stored in the diet recorded database 15 as the diet information which users can have access to anytime and anyplace. Alternatively, the portable device 50 does not need to have physical connection with the external weight platform 60. The weight information is inputted into the portable device 50 via the external weight platform 60 after the weight of the food 40 is measured by the external weight platform 60, which does not connect with the portable device 50. Thus users are allowed to record the diet status real-time when away from home and be fully informed of the overall nutrition intake status.

As the skilled person will appreciate, various changes and modifications can be made to the described embodiments. It is intended to include all such variations, modifications and equivalents which fall within the scope of the invention, as defined in the accompanying claims.

What is claimed is:

1. An electronic scale for recording health administration data, comprising: a micro controller installed in the electronic scale and having at least an embedded application for processing data input, output, analysis, and calculation; a food database module installed in the electronic scale, the food database module connected with the micro controller and having detailed food data item therein; a weight sensing device installed in the electronic scale and connected with the micro controller, and the weight sensing device having a weight platform for receiving the food for weight measuring whereby the food weight is sensed by the weight sensing device; an identification module connected to the micro controller for identifying the data in the identification tag of the food for weight measuring; a screen electronically connected with the micro controller for displaying the operating interface of the embedded application; and a user database module installed in the electronic scale for establishing connections to the micro controller and having at least a user data and at least a recorded data of user diet stored therein; whereby, the identification module promptly retrieves the food related detailed data in the identification tag, information records of calories and nutrition components in the food are calculated, displayed and stored after the weight platform measuring the food weight, the information records are matched with the total consumed food data of the user for providing an excessive or insufficient intake warning for the user.

2. The electronic scale for recording health administration data of claim 1, wherein the identification tag comprises the corresponding food item data.

3. The electronic scale for recording health administration data of claim 1, wherein the identification tag is a barcode and the identification module is a barcode identifier for identifying the barcode.

4. The electronic scale for recording health administration data of claim 1, wherein the identification tag is either a chip tag or a electronic tag, the identification module is a wireless radio frequency reader for identifying the chip tag and the electronic tag.

5. The electronic scale for recording health administration data of claim 1, wherein the user database module comprises a user profile database, a diet recorded database and a diet recommendation database, the user profile database is provided for storing the user data, the diet recorded database is provided for storing user diet data; the diet recommendation database is provided by a medical provider for setting and storing related data of at least a diet intake predetermined standard or diet intake limits according to biological conditions of the user.

6. The electronic scale for recording health administration data of claim 5, wherein, the electronic scale further comprises a connection device connected with the micro controller, the embedded application of the micro controller comprises a inquiry interface; the connection device is provided for establishing connections with an external system; the external system comprises a medical service platform whereby the diet data is uploaded to the medical service platform via the connections; the latest diet medical recommendations provided by the medical service platform are updated to the diet recommendation database.

7. The electronic scale for recording health administration data of claim 1, wherein, the food database module comprises a general food database and a daily food database; the data in the general food database comprises detailed data of food available in the market, and data of daily food database comprises detailed data of food frequently consumed by the user.

8. The electronic scale for recording health administration data of claim 1, wherein, the electronic scale further comprises an input device connected with the micro controller, and the input device is one of a touch screen, an external keyboard or keys, an audio identification device, or a video auto identification device.

9. The electronic scale for recording health administration data of claim 1, wherein, the identification module is installed in a portable device and is comprised of a recording device and an identification application in the portable device.

10. The electronic scale for recording health administration data of claim 9, wherein, the portable device is one of a mobile phone, a PDA or a notebook computer.
